(19) United States
(12) Patent Application Publication
(10) Pub. No.: US 2024/0226820 A1
(43) Pub. Date: Jul. 11, 2024

(54) TETRABLOCK COPOLYMERS AND ARTICLES MADE THEREFROM

(71) Applicant: 3M INNOVATIVE PROPERTIES COMPANY, St. Paul, MN (US)

(72) Inventors: Carl A. Laskowski, Minneapolis, MN (US); Timothy M. Gillard, St. Paul, MN (US); Lucas D. McIntosh, Minneapolis, MN (US); Clinton P. Waller, Jr., White Bear Lake, MN (US)

(21) Appl. No.: 18/553,957

(22) PCT Filed: Apr. 1, 2022
(86) PCT No.: PCT/IB2022/053064

§ 371 Date: Oct. 4, 2023

Related U.S. Application Data
(60) Provisional application No. 63/201,382, filed on Apr. 27, 2021.

(51) Int. Cl. B01D 71/80; B01D 69/02; B01D 69/08; B01D 71/26; B01D 71/46; C08F 297/04

(52) U.S. Cl. CPC B01D 71/80; B01D 69/02; B01D 69/08; B01D 71/26; B01D 71/46; C08F 297/046; C08F 297/048; B01D 2325/36

(57) ABSTRACT

Tetrablock copolymers of formula ABAC are provided that can be used to form porous articles such as porous hollow fibers and porous membranes. Each A block is formed from a vinyl aromatic monomer, the B block is formed from a conjugated diene monomer, and the C block is formed from at least two different oxirane (i.e., epoxy) compounds. The tetrablock copolymers can advantageously be prepared without the use of functional initiators and/or difunctional initiators. The tetrablock copolymers are well suited for solvent induced phase separation (SIPS) processing to prepare porous articles. Membranes formed from the tetrablock copolymers can be used for water treatment and biopharmaceutical purification and/or separation processes.

### BACKGROUND

Porous articles typically have a porous structure that allows fluids to pass readily through them. Some porous articles are membranes that can be used in a wide range of divergent applications such as in fluid filtration for removal of solid particulates, in ultrafiltration for removal of colloidal matter, and in electrochemical cells as diffusion barriers or separators. Porous membranes have also been used in the filtration of antibiotics, beers, oils, bacteriological broths, and in the purification and/or analysis of air, microbiological samples, intravenous fluids, and vaccines.

Porous membranes based on block copolymers are of interest. The block copolymers are typically amphiphilic such as the pentablock copolymers described in patent application US 2019/0322788A1 (Laskowski et al.). These pentablock copolymers were prepared using a telechelic, hydroxy-terminated triblock copolymer precursor accessed using one of three methods as shown in Reaction Schemes (I), (II) and (III) with blocks formed from styrene and isoprene.

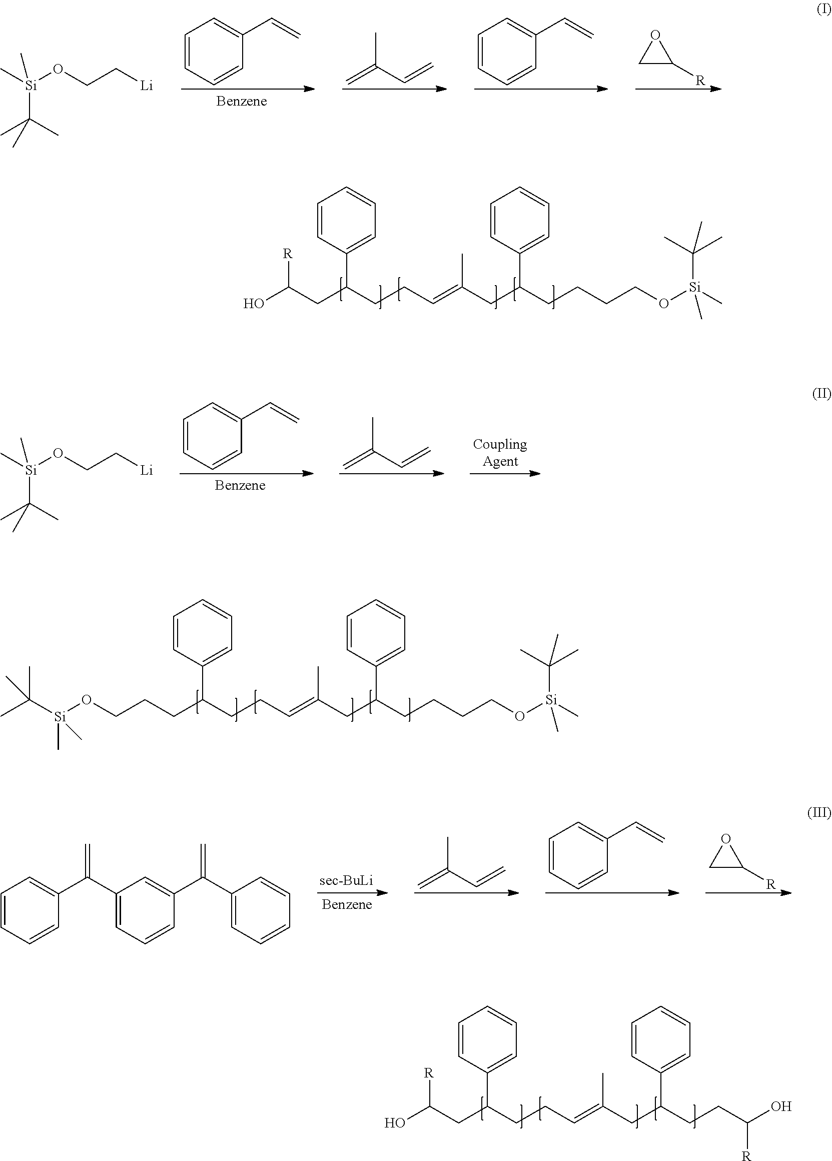

All three methods rely on the use of either a functionalized/protected initiator or a difunctional initiator for anionic polymerization. Both functionalized and difunctional initiators for carbon-centered anionic polymerization suffer from practical limitations.

As shown in Reaction Schemes (I) and (II), the use of a functionalized initiator results in inclusion of the protecting group in the obtained polymers. The protecting group of the functionalized initiator must be removed from the triblock precursor prior to chain extension, adding a time-consuming step (Bates et. al. Macromolecules, 2007, 40, 760). For the case of tert-butyldimethylsilyl (TBDMS) and other silyl ether protecting groups, harsh deprotecting reagents such as tetrabutylammonium fluoride (TBAF) are used to cleave the Si—O bond. Furthermore, it is beneficial to remove residual TBDMS fragments as well as any excess TBAF prior to chain extension, as these contaminants may act as additional initiators in further anionic polymerizations.

Difunctional anionic initiators may also be used as shown in Reaction Scheme (III) to access a telechelic hydroxy-terminated precursor for amphiphilic pentablock copolymers, but these reagents suffer from their own limitations. The identity of the solvent used during anionic polymerization can significantly impact the properties of the product polymer. For example, a small amount of non-protic polar additive (e.g., such as trace amounts of THF) can alter the 1,2-polybutadiene content of butadiene polymerized in cyclohexane from about 7 mole percent to greater than 40 mol mole percent. This increase in 1,2-polybutadiene content can in turn affect oxidative stability and mechanical performance of the product polymer (see Hsieh et al., Polymerization: Principles and Practical Applications; Plastics Engineering; Dekker, New York, 1996, pages 217-22).

The number of difunctional initiators soluble in purely hydrocarbon solvents is very limited. These hydrocarbon-soluble difunctional initiators are usually prepared from the stoichiometric reaction of sec-butyl lithium or tert-butyl lithium. If mono-disperse polymers are to be obtained, the lithiation of the difunctional initiator precursor must be complete and excess sec-butyl lithium or tert-butyl lithium reagent must be removed prior to polymerization (see Hsieh et al., Anionic Polymerization: Principles and Practical Applications; Plastics Engineering; Dekker, New York, 1996, pages 110-113 and 316-319). As a result, either a difficult, stoichiometrically precise reaction must be attempted or a time-consuming purification of the air and moisture-sensitive difunctional initiator is required prior to diene polymerization.

Similarly, a further drawback of Reaction Scheme (II) for producing a telechelic triblock copolymer is the use of a difunctional coupling agent. Any deviation from precise stoichiometry results in inefficient and incomplete coupling and undesirable bimodal molecular weight distributions. (see Hsieh et al., Anionic Polymerization: Principles and Practical Applications; Plastics Engineering: Dekker, New York, 1996, pages 315-316).

Both silyl ether-protected and difunctional initiators have been shown to benefit from the use of benzene as a polymerization solvent. This is attributed to solubility of the initiator and the faster kinetics of initiation in benzene as compared to other hydrocarbon solvents such as cyclohexane. As the use of benzene is increasingly restricted due to health and environmental concerns, polymerization methods and materials that exclude its use are a practical improvement.

Recently, the combination of solvent induced phase separation (SIPS) with block copolymer materials has been shown to yield porous membranes with uniform pores. However, the resulting membranes often suffer from poor mechanical properties that inhibit their commercial adoption. Furthermore, because the SIPS process typically requires the use of an aqueous non-solvent bath, identifying polymers that precipitate from water, yet possess high hydrophilic character continues to be a challenge.

### SUMMARY

Tetrablock copolymers of formula ABAC are provided that can be used to form porous articles such as porous hollow fibers and porous membranes. Each A block is formed from a vinyl aromatic monomer, the B block is formed from a conjugated diene monomer, and the C block is formed from at least two different oxirane (i.e., epoxy) compounds. The tetrablock copolymers can advantageously be prepared without the use of functional and/or difunctional initiators. The relative ease of preparation of the tetrablock copolymers using readily available anionic polymerization initiators can make them an attractive alternative to the pentablock copolymers described in patent application US 2019/0322788A1 (Laskowski et al.). The tetrablock copolymers are well suited for solvent induced phase separation (SIPS) processing to prepare porous articles. Membranes formed from the tetrablock copolymers can be used, for example, for water treatment and for biopharmaceutical purification and/or separation processes.

In a first aspect, a tetrablock copolymer of formula ABAC is provided. The tetrablock copolymer has two A blocks and each A block comprises monomeric units derived from a vinyl aromatic monomer. The B block comprises monomeric units derived from a conjugated diene monomer, wherein the B block is unsaturated or hydrogenated. The C block comprises 10 to 70 mole percent of first monomeric unit of Formula (I) and a 30 to 90 mole percent of second monomeric unit of Formula (II) based on total moles of monomeric units in the C block.

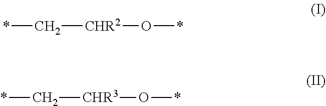

In Formula (I), R² is hydrogen, —CH₂OH, or —CH₂—(OCH₂CH₂)ₙ—OCH₃ where n is an integer ranging from 1 to 6. Group R³ in Formula (II) is an alkyl or a group of formula —CH₂—O—R⁴ where R⁴ is an alkyl or allyl group. Each asterisk (*) indicates the attachment site to another monomeric unit in the C block.

In a second aspect, an article is provided that contains the tetrablock copolymer described in the first aspect. In many embodiments, the article is porous. For example, the article can be a porous membrane or a porous hollow fiber.

In a third aspect, a method of making the tetrablock copolymer is provided. The method includes mixing a first initiator for carbon-centered anionic polymerization with a first vinyl aromatic monomer in a reaction vessel, and then forming a first reaction product that is a first polymeric block A comprising a polymerized product of at least 90 weight percent of the first vinyl aromatic monomer. The method further includes adding a conjugated diene monomer to the reaction vessel and forming a second reaction product that is a diblock copolymer of formula AB wherein first polymer block A is bonded to a second polymer block B comprising a polymerized product of at least 90 weight percent of the conjugated diene monomer. The method still further includes adding a second vinyl aromatic monomer that is the same or different than the first vinyl aromatic monomer to the reaction vessel and forming a third reaction product that is a triblock copolymer of formula ABA wherein the diblock copolymer of formula AB is bonded to a third polymer block A comprising a polymerized product of at least 90 weight percent of the second vinyl aromatic monomer. The method yet further includes forming and isolating a hydroxy-terminated triblock copolymer of formula ABA-R¹—OH from the third reaction product, wherein R¹ is ethylene or propylene. The method still further includes mixing the hydroxy-terminated triblock copolymer with a second initiator for oxygen-centered anionic polymerization, a first oxirane compound, and a second oxirane compound different than the first oxirane compound and then preparing a copolymer of formula ABAC wherein the triblock copolymer of formula ABA is bonded to a C block that comprises 10 to 70 mole percent first monomeric unit of Formula (I) and 30 to 90 mole percent of second monomeric unit of Formula (II) based on total moles of monomeric units in the C block.

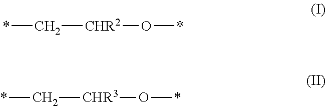

In Formula (I), R² is hydrogen, —CH₂OH, or —CH₂—(OCH₂CH₂)ₙ—OCH₃ where n is an integer ranging from 1 to 6. Group R³ in Formula (II) is an alkyl or a group of formula —CH₂—O—R⁴ where R⁴ is an alkyl or allyl group. Each asterisk (*) indicates the attachment site to another monomeric unit in the C block. The monomeric unit of Formula (I) is derived from the first oxirane compound and the monomeric unit of Formula (II) is derived from the second oxirane compound.

In a fourth aspect, a method of making a porous membrane is provided. The method includes forming a tetrablock copolymer as described in the first aspect. The method further includes mixing the tetrablock copolymer with an organic solvent or organic solvent mixture that is miscible with water to form a tetrablock copolymer solution or dispersion. The method yet further includes casting a first membrane on a substrate from the tetrablock copolymer solution or dispersion to form a first article. The method still further includes immersing the first article in an aqueous bath at a temperature greater than room temperature (e.g., in a range of about 25 to about 70 degrees Celsius) to precipitate the tetrablock copolymer and form a second article comprising a porous membrane. The method involves removing the second article from the aqueous bath and optionally separating the porous membrane from the substrate.

The terms “a”, “an”, and “the” are used interchangeably and mean one or more.

The term “and/or” means to one or both. For example, the expression X and/or Y means X alone, Y alone, or both X and Y.

The term “alkyl” refers to a monovalent group that is a radical of an alkane and includes groups that are linear, branched, cyclic, bicyclic, or a combination thereof. Unless otherwise indicated, the alkyl groups typically contain from 1 to 20 carbon atoms. In some embodiments, the alkyl groups contain 1 to 10 carbon atoms, 2 to 10 carbon atoms, 1 to 6 carbon atoms, 2 to 6 carbon atoms, 1 to 4 carbon atoms, or 2 to 4 carbon atoms. Cyclic alkyl groups and branched alkyl groups have at least three carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “heteroalkyl” refers to an alkyl where one or more of the carbon atoms in the chain are replaced with a heteroatom that is usually oxygen, nitrogen, or sulfur. In many embodiments, the heteroatom is oxygen and the heteroalkyl has one or more —CH₂—O—CH₂— groups.

The term “(hetero)alkyl” refers to an alkyl, heteroalkyl, or both.

The term “allyl” refers to a —CH₂—CH═CH₂ group.

The term “aryl” refers to a monovalent group that is aromatic and, optionally but usually, carbocyclic. The aryl has at least one aromatic ring. Any additional rings can be unsaturated, partially saturated, saturated, or aromatic. Optionally, the aromatic ring can have one or more additional carbocyclic rings that are fused to or connected to the aromatic ring. Unless otherwise indicated, the aryl groups typically contain from 6 to 20 carbon atoms. In some embodiments, the aryl groups contain 6 to 18, 6 to 16, 6 to 12, or 6 to 10 carbon atoms. Examples of an aryl group include phenyl, naphthyl, biphenyl, phenanthryl, and anthracyl.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms, and an aryl portion often has 6 to 20 carbon atoms, 6 to 18 carbon atoms, 6 to 16 carbon atoms, 6 to 12 carbon atoms, or 6 to 10 carbon atoms.

The term “monomeric unit” refers to a polymerized product of a monomer. For example, the monomeric unit associated with the monomer propylene oxide

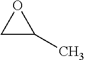

is *—CH₂—CH(CH₃)—O—* where each asterisk (*) shows a location where the monomeric unit is attached to another monomeric unit or a terminal group of a polymeric material.

The term “oxirane” refers to a compound of formula

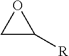

where R is hydrogen or a (hetero)alkyl that is optionally substituted with a hydroxy group.

The term “room temperature” refers to temperatures in a range of 20 to 25 degrees Celsius or in a range of 22 to 25 degrees Celsius.

### BRIEF DESCRIPTION OF THE DRAWINGS

FIG. 1A is an Atomic Force Micrograph showing the different phases present in the tetrablock copolymer of Example 14.

FIG. 1B is an Atomic Force Micrograph showing the different heights present in the tetrablock copolymer of Example 14.

FIG. 2A is an Atomic Force Micrograph showing the different phases present in the tetrablock copolymer of Example 16.

FIG. 2B is an Atomic Force Micrograph showing the different heights present in the tetrablock copolymer of Example 16.

### DETAILED DESCRIPTION

Tetrablock copolymers of formula ABAC are provided where each A block is formed from a vinyl aromatic monomer, the B block is formed from a conjugated diene monomer, and the C block is formed from at least two different oxirane compounds. The tetrablock copolymers are amphiphilic and can be used with solvent-induced phase separation (SIPS) to prepare porous articles. The porous articles are usually a hollow fiber or a membrane. In many embodiments, the porous article is a membrane that is suitable for water treatment and for biopharmaceutical purification and/or separation processes.

The tetrablock copolymer is linear and is synthesized though sequential anionic polymerization of a first A block, a B block, and a second A block. The resulting ABA triblock copolymer is terminated with ethylene oxide or propylene oxide, isolated (which can include treatment with an acidic material) and dried to form a hydroxy terminated ABA triblock. The hydroxy terminated ABA triblock copolymer is then chain extended by reacting with two different types of oxirane compounds to yield the ABAC tetrablock copolymer. The identity of the C block plays an important role in the formation of a porous article using SIPS with an aqueous bath for precipitation.

The use of a water miscible block or a water-soluble block can often inhibit precipitation of a cast film of the block copolymer and can result in either the dissolution of the block copolymer in the aqueous bath or formation of gels that densify upon drying. In the ABAC tetrablock copolymers described herein, however, an aqueous bath can be used for precipitation in the SIPS process due to the presence of a C block that is formed from two different oxirane compounds with different degrees of hydrophilicity. The C block copolymer used in the ABAC tetrablock often exhibits a cloud point greater than 10 degrees Celsius and lower than 60 degrees Celsius in a five-weight percent aqueous solution. That is, the five-weight percent aqueous solution of the C block copolymer appears hazy when heated through this temperature range. The ABAC tetrablock copolymers can be precipitated in water ranging, for example, from room temperature (e.g., 20 to 25 degrees Celsius) to about 70 degrees Celsius or about 60 degrees Celsius. The resulting porous articles often have a surface that is hydrophilic.

The tetrablock copolymer contains two A blocks (e.g., a first block A and a second block A) that are the same or different. The A blocks are hydrophobic with each A block independently being a polymerized product of a vinyl aromatic monomer. Suitable vinyl aromatic monomers include, but are not limited to, styrene, α-methylstyrene, 4-methylstyrene, 3-methylstyrene, 4-ethylstyrene, 3,4-dimethyl styrene, 2,4,6-trimethylstyrene, 3-tert-butylstyrene, 4-tert-butylstyrene, 4-methoxystyrene, 4-trimethysilylstyrene, 2,6-dichlorostyrene, vinyl naphthalene, 4-chlorostyrene, 3-chlorostyrene, 4-fluorostyrene, 4-bromostyrene, vinyl anthracene, and mixtures thereof. In some embodiments, one or both A blocks are formed from styrene and/or 4-tert-butylstyrene.

Each A block is a hard, glassy block with a glass transition temperature (Tg) of at least 50 degrees Celsius as measured using Differential Scanning Calorimetry. The glass transition temperature is often at least 60 degrees, at least 70 degrees, at least 80 degrees, at least 90 degrees, or at least 100 degrees Celsius. The glass transition temperature is determined by the selection of the vinyl aromatic monomers used to form each A block.

The tetrablock copolymer contains at least 35 weight percent of the A blocks (first A block plus second A block) based on a total weight of the tetrablock copolymer. For example, the total amount of the A blocks can be at least 40 weight percent, at least 45 weight percent, at least 50 weight percent, at least 55 weight percent, at least 60 weight percent, at least 65 weight percent, or at least 70 weight percent and up to 75 weight percent, up to 70 weight percent, up to 65 weight percent, up to 60 weight percent, up to 55 weight percent, or up to 50 weight percent. The total amount of A blocks is often in a range of 35 to 75 weight percent, 40 to 70 weight percent, 45 to 65 weight percent, or 50 to 60 weight percent based on the total weight of the tetrablock copolymer.

Usually, each A block is independently in a range of 15 to 40 weight percent based on the total weight of the tetrablock copolymer providing that the total weight of A blocks is in the range of 35 to 75 weight percent. The amount of each A block can be at least 15 weight percent, at least 20 weight percent, at least 25 weight percent, or at least 30 weight percent and up to 40 weight percent, up to 35 weight percent, up to 30 weight percent, up to 25 weight percent, or up to 20 weight percent.

The B block is a hydrophobic block positioned between the first and second A blocks and is bonded to each A block. The B block is the polymerized product of a conjugated diene. Suitable conjugated dienes include, but are not limited to, butadiene, isoprene, and various 1,3-cyclodiene monomers such as 1,3-cyclohexadiene, 1,3-cycloheptadiene, 1,3-cyclooctadiene, and mixtures thereof. As formed, the B block is unsaturated but optionally it can be hydrogenated. If fully hydrogenated, the resulting B block is often a poly(ethylene-alt-propylene), poly(butylene), poly(ethylene-co-butylene), or poly(ethylene-co-propylene-co-butylene) block.

For B blocks that are hydrogenated, the extent of hydrogenation can be varied. Of the total moles of double bonds in the original B block, the mole percent remaining after hydrogenation is often in a range of 0 to 40 mole percent. That is, hydrogenation converts 60 to 100 mole percent of the carbon-carbon double bonds to carbon-carbon single bonds. The double bonds remaining can be at least 5 mole percent, at least 10 mole percent, at least 15 mole percent, at least 20 mole percent, at least 25 mole percent, at least 30 mole percent, and up to 40 mole percent, up to 35 mole percent, up to 30 mole percent, up to 25 mole percent, and up to 20 mole percent based on the total moles of double bonds in the B block prior to hydrogenation. The mole percent unsaturation can be determined using NMR spectroscopy.

The B block, which can be unsaturated or hydrogenated, usually has a glass transition temperature that is no greater than 20 degrees, no greater than 10 degrees, or no greater than 0 degrees Celsius as measured using Differential Scanning Calorimetry. The glass transition temperature is determined by the selection of the conjugated diene used to form each B block.

The tetrablock copolymer typically contains at least 10 weight percent B block based on the total weight of the tetrablock copolymer. The amount can be at least 10 weight percent, at least 15 weight percent, at least 20 weight percent, at least 25 weight percent, at least 30 weight percent, or at least 35 weight percent and up to 45 weight percent, up to 40 weight percent, up to 35 weight percent, up to 30 weight percent, up to 25 weight percent, up to 20 weight percent, or up to 15 weight percent. The amount is often in a range of 10 to 45 weight percent, 15 to 40 weight percent, 20 to 40 weight percent, or 25 to 35 weight percent based on the total weight of the tetrablock copolymer.

The weight ratio of the A blocks to the B block is often in a range of 4:1 to 1:1. For example, the weight ratio can be in a range of 3:1 to 1:1, 2.5:1 to 1:1, 2:1 to 1:1, or 1.5:1 to 1:1.

The C block is bonded to one A block but not to both A blocks. The C block is selected so that it is not miscible in either the A block or the B block. The C block is hydrophilic and is a polymerized product of at least two different oxirane compounds. The at least two different oxirane compounds are selected based on miscibility differences in water of their corresponding monomeric units. The first monomeric units, which are derived from the first oxirane compound, are miscible in water when present as a homopolymer while the second monomeric units, which are derived from the second oxirane compound, have limited solubility in water when present as a homopolymer.

The first oxirane compound is typically of Formula (III).

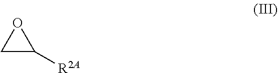

In Formula (III), R^{2A} is hydrogen, —CH₂O—CH(CH₃)—O—CH₂CH₃, or —CH₂—(OCH₂CH₂)ₙ—OCH₃ where n is an integer ranging from 1 to 6 such as 1 to 5, 1 to 4, 1 to 3, or 1 to 2. Examples of the first oxirane compound include ethylene oxide, ethoxyethyl-glycidyl ether, the glycidyl ethers of di(ethyleneglycol) monomethylether, tri(ethyleneglycol) monomethylether, tetra(ethyleneglycol) monomethylether, and penta(ethyleneglycol) monomethylether. If the first oxirane compound is an ethoxyethyl-glycidyl ether with the R^{2A} group being —CH₂O—CH(CH₃)—O—CH₂CH₃, treatment with an acidic solution after polymerization will convert this R^{2A} group to —CH₂OH.

In the final C block, the first oxirane compound is present in the form of monomeric units of Formula (I).

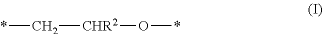

The group R² is hydrogen, —CH₂OH, or —CH₂—(OCH₂CH₂)ₙ—OCH₃ where n is an integer ranging from 1 to 6 such as 1 to 5, 1 to 4, 1 to 3, or 1 to 2. Each asterisk is the site of attachment to another monomeric unit in the C block.

The second oxirane compounds are typically of Formula (IV).

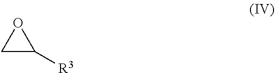

In Formula (IV), R³ is an alkyl or a group of formula —CH₂—O—R⁴ where R⁴ is an alkyl or allyl group. The alkyl group for R³ and R⁴ often has 1 to 3 carbon atoms. In many embodiments the alkyl is methyl or ethyl. Examples of the second oxirane compound include propylene oxide, butylene oxide, allyl glycidyl ether, and methyl glycidyl ether.

In the final C block, the second oxirane compound of Formula (IV) is present in the form of monomeric units of Formula (II).

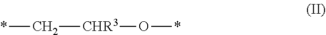

Group R³ in Formula (II) is an alkyl or a group of formula —CH₂—O—R⁴ where R⁴ is an alkyl or allyl group. Each asterisk (*) indicates the attachment site to another monomeric unit in the C block.

In some embodiments of the C block, group R² in the monomeric unit of Formula (I) is —CH₂OH and group R³ in the monomeric unit of Formula (II) is methyl. Such a C block can be prepared by using a first oxirane compound that is a protected glycidol compound such as ethoxy-ethylglycidyl ether and a second oxirane compound that is propylene oxide. After formation of the C block, the tetrablock copolymer can be treated with an acidic solution to remove the protection group form the monomeric units resulting from the protected glycidol compound.

The C block usually contains 10 to 70 mole percent first monomeric unit of Formula (I) and 30 to 90 mole percent second monomeric unit of Formula (II) based on total moles of monomeric units in the C block. In some examples, the C block contains 10 to 60 mole percent first monomeric unit of Formula (I) and 40 to 90 mole percent second monomeric unit of Formula (II), 10 to 55 mole first monomeric unit of Formula (I) and 45 to 90 mole percent second monomeric unit of Formula (II), 10 to 50 mole first monomeric unit of Formula (I) and 50 to 90 mole percent second monomeric unit of Formula (II), 10 to 40 mole first monomeric unit of Formula (I) and 60 to 90 mole percent second monomeric unit of Formula (II), or 10 to 30 weight mole first monomeric unit of Formula (I) and 70 to 90 mole percent second monomeric unit of Formula (II).

The C block copolymer often exhibits a cloud point at temperatures greater than 10 degrees Celsius and lower than 60 degrees Celsius in a five-weight percent aqueous solution. This characteristic often occurs when the second oxirane compound is propylene oxide. More particularly, this characteristic often occurs when R² in the first monomeric unit of Formula (I) is —CH₂OH (i.e., corresponding to a first oxirane compound being ethoxy-ethylglyciyl ether with the C block treated with an acid) and R³ in the second monomeric unit of Formula (II) is methyl (i.e., corresponding to a second oxirane compound being propylene oxide). Even more particularly, this characteristic occurs when the C block contains 10 to 55 mole percent of the first monomeric unit with R² in Formula (I) being —CH₂OH and 45 to 90 mole percent of the second monomeric unit with R³ in Formula (II) being methyl.

The tetrablock copolymer contains at least 10 weight percent block C based on the total weight of the tetrablock copolymer. The amount can be at least 15 weight percent, at least 20 weight percent, or at least 25 weight percent and up to 30 weight percent, up to 25 weight percent, or up to 20 weight percent. The amount of the C block is often in a range of 10 to 30 weight percent, 15 to 30 weight percent, 10 to 25 weight percent, or 15 to 25 weight percent based on the total weight of the tetrablock copolymer.

Overall, the tetrablock copolymer contains 10 to 30 weight percent C block with the weight ratio of the A block to the B block being in a range of 4:1 to 1:1. The tetrablock copolymer usually contains at least 35 weight percent A block, at least 10 weight percent B block, and at least 10 weight percent C block based on a total weight of the tetrablock copolymer. In some examples, the tetrablock copolymer contains 35 to 75 weight percent A blocks, 10 to 45 weight percent B block, and 10 to 30 weight percent C block. In other examples, the tetrablock copolymer can contain 40 to 70 weight percent A block, 20 to 45 weight percent B block, and 10 to 30 weight percent C block. In yet other examples, the tetrablock copolymer contains 40 to 70 weight percent A block, 20 to 40 weight percent B block, and 10 to 30 weight percent C block.

The tetrablock copolymer usually has a weight average molecular weight ranging from 60,000 to 200,000 grams/mole. The weight average molecular weight is at least 60,000 grams/mole, at least 80,000 grams/mole, at least 100,000 grams/mole, at least 120,000 grams/mole, at least 140,000 grams/mole, or at least 150,000 grams/mole and up to 200,000 grams/mole, up to 180,000 grams/mole, up to 160,000 grams/mole, up to 150,000 grams/mole, up to 140,000 grams/mole, up to 120,000 grams/mole, or up to 100,000 grams/mole. The weight average molecular weight is often determined using gel permeation chromatography (GPC).

The tetrablock copolymer typically has a polydispersity index no greater than 1.5, no greater than 1.4, no greater than 1.3, no greater than 1.2, and no greater than 1.1. The polydispersity index is calculated by dividing the weight average molecular weight by the number average molecular weight with the weight average molecular weight and the number average molecular weight being determine by gel permeation chromatography. A polydispersity index is an indicator of the molecular weight distribution with values closest to 1.0 having the narrowest distribution.

Any suitable method can be used to prepare the tetrablock copolymer. In most embodiments, the method includes sequential anionic polymerization of the first A block, the B block, and the second A block with a first initiator for anionic polymerization. The resulting ABA triblock is end-capped with a hydroxyl group using an alkylene oxide termination reagent, isolated and then mixed with a second initiator for anionic polymerization to prepare the C block. The first initiator is used for carbon-centered propagating anions (i.e., carbon-centered anionic polymerization) while the second initiator is used for oxygen-centered propagating anions (i.e., oxygen-centered anionic polymerization).

The first initiator for carbon-centered propagating anions is usually an alkali metal hydrocarbon. The hydrocarbon often has at least 2 carbon atoms, at least 4 carbon atoms, at least 6 carbon atoms, or at least 8 carbon atoms and up to 20 carbon atoms, up to 16 carbon atoms, up to 12 carbon atoms, up to 8 carbon atoms, or up to 6 carbon atoms. The hydrocarbon is often an alkyl, aryl, aralkyl, or alkaryl group. The alkali metal is often sodium, potassium, or lithium. Examples of such first initiators are benzylsodium, ethylsodium, propylsodium, phenylsodium, butylpotassium, octylpotassium, benzylpotassium, benzyllithium, methyllithium, ethyllithium, n-butyllithium, sec-butyllithium, tert-butyllithium, amyllithium, phenyllithium, 2-ethylhexyllithium, and the like. In many embodiments, the lithium compounds are preferred as the first initiator. The first initiator is often sec-butyllithium.

The first initiator can be used in the reaction mixture in an amount calculated based on one initiator molecule per desired polymer chain. That is, the molecular weight is inversely related to the amount of the first initiator added to the reaction mixture. The first initiator is mixed with the monomers used to form the first A block. The first initiator is typically only added at the time the A block is formed.

The first initiator for carbon-centered anionic polymerization reactions is combined with the vinyl aromatic monomers to form a first reaction mixture. Optionally an organic solvent can be added to the first reaction mixture. Suitable organic solvents are those that are miscible with the vinyl aromatic monomers and are typically a hydrocarbon such as, for example, cyclohexane.

The first polymerization reaction to form the first A block often occurs at room temperature or at a temperature between room temperature and about 50 degrees Celsius. The first polymerization reaction typically proceeds until at least 90 weight percent of the vinyl aromatic monomer in the first reaction mixture has been polymerized. That is, the first reaction product is a first polymeric block A comprising a polymerized product of at least 90 weight percent of the vinyl monomers present in the first reaction mixture. In some embodiments, at least 92 weight percent, at least 95 weight percent, at least 97 weight percent, at least 98 weight percent, at least 99 weight percent, at least 99.5 weight percent, at least 99.7 weight percent, or even at least 99.9 weight percent of the vinyl aromatic monomer have been polymerized.

In a second step, a conjugated diene monomer is added to the first reaction product to form a second reaction mixture. The second polymerization reaction to form the B block often occurs at room temperature or at a temperature between room temperature and about 50 degrees Celsius. The second polymerization reaction typically proceeds until at least 90 weight percent of the conjugated diene in the second reaction mixture has been polymerized. That is, the B block comprises a polymerized product of at least 90 weight percent of the conjugated dienes present in the second reaction mixture. In some embodiments, at least 92 weight percent, at least 95 weight percent, at least 97 weight percent, at least 98 weight percent, at least 99 weight percent, at least 99.5 weight percent, at least 99.7 weight percent, or even at least 99.9 weight percent of the conjugated diene monomers have been polymerized. The second reaction product is a diblock copolymer of formula AB wherein the first polymer block A is bonded to the second polymer block B.

In a third step, a second vinyl aromatic monomer is added to the second reaction product to form a third reaction mixture. The second vinyl aromatic monomer, which is used to form the second A block, can be the same or different than the first vinyl aromatic monomer used to form the first A block. The third polymerization reaction to form the second A block often occurs at room temperature or at a temperature between room temperature and about 50 degrees Celsius. The third polymerization reaction typically proceeds until at least 90 weight percent of the second vinyl aromatic monomer in the third reaction mixture has been polymerized. That is, the second A block comprises a polymerized product of at least 90 weight percent of the vinyl aromatic monomers present in the third reaction mixture. In some embodiments, at least 92 weight percent, at least 95 weight percent, at least 97 weight percent, at least 98 weight percent, at least 99 weight percent, at least 99.5 weight percent, at least 99.7 weight percent, or even at least 99.9 weight percent of the vinyl aromatic monomers have been polymerized. The third reaction product is a triblock copolymer of formula ABA wherein the AB diblock copolymer is bonded to a second A block.

The method further includes forming a hydroxy-terminated triblock copolymer of formula ABA-R¹—OH from the third reaction product. The hydroxy-terminated triblock copolymer is formed in several steps. First, the third reaction product of formula ABA is reacted with propylene oxide or ethylene oxide and then optionally treated with an acid, which refers to any compound more acidic (i.e., having a lower pKa) than the conjugate acid of the terminal oxanion derived from the ring opening of propylene oxide or ethylene oxide, such as hydrochloric acid or methanol. In most embodiments, the hydroxy-terminated triblock copolymer ABA-R¹—OH is precipitated and collected by filtration to remove residual solvents, any remaining propylene oxide or ethylene oxide, and unreacted monomers. If desired, the filtered hydroxy-terminated triblock copolymer can be dried under vacuum. That is, in many embodiments, the hydroxy-terminated triblock copolymer is isolated and dried.

The isolated and dried hydroxy-terminated triblock copolymer is further polymerized to form the C block from two different oxirane compounds with the C block bonded to the ABA triblock with the group —R¹—O— being part of the C block. This fourth polymerization step is conducted in the presence of a second initiator for oxygen-centered anionic polymerization reactions and a Lewis acid catalyst. An optional organic solvent such as toluene can be added.

The second initiator for oxygen-centered anionic polymerization reactions is typically a highly basic but weakly nucleophilic base known in the art such as, for example, in the article Herzberger et al., Chem. Rev., 2016, 116, 4, 2170-2243. Suitable bases include phosphazene bases and other organic superbases. Suitable phosphazene bases include 1-tert-Butyl-4,4,4-tris(dimethylamino)-2,2-bis[tris(dimethyl-amino)-phosphoranylidenamino]-2λ5, 4λ5-catenadi(phosphazene) (t-BuP4) and 1-tert-butyl-2,2,4,4,4-pentakis(dimethylamino)-2λ5,4λ5-catenadi-(phosphazene) (t-BuP2). Other suitable bases include [2,5,8,9-tetraaza-1-phosphabicyclo[3.3.3]undecane-2,8,9-tris(1-methylethyl)], 2,8,9-triisobutyl-2,5,8,9-tetraaza-1-phosphabicyclo[3.3.3]undecane, and 2,8,9-trimethyl-2,5,8,9-tetraaza-1-phosphabicyclo[3.3.3]undecane (also collectively known as Verkade's bases).

Suitable Lewis acids are often selected from trialkyl aluminum and trialkyl borane compounds. Examples include, but are not limited to, triethyl aluminum, triisobutyl aluminum, and triethyl borane.

The fourth reaction mixture typically contains the hydroxy-terminated copolymer of formula ABA-R¹—OH, a first oxirane compound of Formula (III), a second oxirane compound of Formula (IV), a second initiator for oxygen-centered anionic polymerization reactions, and a Lewis acid catalyst. The fourth polymerization reaction to form the C block often occurs at room temperature or at a temperature between room temperature and about 50 degrees Celsius. The fourth reaction product is the tetrablock copolymer of formula ABAC or a precursor thereof if the C block was formed using ethoxyethyl-glycidyl ether.

The ABAC tetrablock copolymer or the precursor thereof is often precipitated from an alcohol such as methanol. If the fourth reaction product is a precursor of the final ABAC tetrablock, the precursor can be treated with an acid such as hydrochloric acid to convert the R^{2A} group from —CH₂O—CH(CH₃)—O—CH₂CH₃ to —CH₂OH. The final ABAC tetrablock copolymer is usually filtered and dried to a powder. The final tetrablock copolymer has a C block comprising 10 to 70 mole percent first monomeric unit of Formula (I) and a 30 to 90 mole percent of second monomeric unit of Formula (II) based on total moles of monomeric units in the C block.

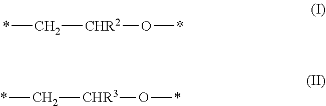

In Formula (I), R² is hydrogen, —CH₂OH, or —CH₂—(OCH₂CH₂)ₙ—OCH₃ where n is an integer ranging from 1 to 6. Group R³ in Formula (II) is an alkyl or a group of formula —CH₂—O—R⁴ where R⁴ is an alkyl or allyl group. Each asterisk (*) indicates the attachment site to another monomeric unit in the C block. The monomeric unit of Formula (I) is derived from the first oxirane compound and the monomeric unit of Formula (II) is derived from the second oxirane compound.

In some embodiments, the B block of the copolymer can be partially or fully hydrogenated. The hydrogenation reaction can occur after formation of the hydroxy-terminated triblock of formula ABA-R¹—OH or after formation of the complete ABAC tetrablock copolymer. The hydrogenation reaction can be done using molecular hydrogen or hydrazine that is generated from the thermolysis of tosyl hydrazide. If molecular hydrogen is used, the reaction is performed in the presence of a catalyst. The catalyst often is a metal such as nickel, cobalt, rhodium, ruthenium, palladium, platinum, other Group VIII metals, combinations thereof, or alloys thereof deposited on a support such as silica or calcium carbonate. The hydrogenation reaction can be conducted in the presence of a solvent in which the block copolymer is soluble and that does not hinder the hydrogenation reaction. The temperature of the hydrogenation reaction is selected so that hydrogenation occurs without degradation of the copolymer. For example, the temperature is often in a range of about 40 degrees Celsius to about 200 degrees Celsius.

In another aspect, an article is provided that contains the ABAC tetrablock. For example, the ABAC tetrablock can be in the form of a film or hollow fiber. In some embodiments, the ABAC tetrablock is porous. Porous ABAC tetrablocks can be, for example, in the form of a porous membrane or a porous hollow fiber. The porous membranes are usually porous throughout the thickness of the membrane.

A method of making a porous article is provided. The method includes preparing a solution or dispersion of the ABAC tetrablock copolymer in an organic solvent and casting a film (e.g., membrane) or hollow fiber from the solution or dispersion. The method still further includes placing the film or hollow fiber in an aqueous bath to precipitate the porous article comprising a plurality of pores. That is, solvent induced phase separation (SIPS) methods are used in the process of forming the porous article.

The method of making the porous article includes preparing a solution or dispersion of the ABAC tetrablock copolymer in an organic solvent. The organic solvent can include one or more solvents. Examples of suitable organic solvents include, but are not limited to, dimethylformamide, dimethylacetamide, N-methylpyrrolidone, dimethylsulfoxide, tetrahydrofuran, 1,4-dioxane, 1,3-dioxane, tetrahydrothiophene 1,1-dioxide, methyl ethyl ketone, methyl tetrahydrofuran, sulfolane, isopropyl alcohol, methyl isobutyl ketone, acetone, acetonitrile, and combinations thereof. The organic solvent is often a mixture containing organic solvents with different boiling points. The organic solvent or mixture is typically miscible with water. If desired, other compounds such as antioxidants can be added to the organic solvent.

The amount of the ABAC tetrablock in the solution or dispersion is often in a range of 5 to 35 weight percent based on the total weight of the solution or dispersion. The amount can be at least 5 weight percent, at least 10 weight percent, at least 15 weight percent, at least 20 weight percent and up to 35 weight percent, up to 30 weight percent, up to 25 weight percent, or up to 30 weight percent.

Although hollow fibers can be formed by spinning the solution or dispersion, the solution or dispersion is typically coated onto a substrate as a film (i.e., a first membrane). If desired, at least some of the organic solvent (e.g., 0.1 to 100 weight percent) can then be removed by evaporation. Next, the film can be placed in an aqueous bath to precipitate the porous membrane (i.e., a second membrane). The C block copolymer used in the ABAC tetrablock often exhibits a cloud point greater than 10 degrees Celsius and lower than 60 degrees Celsius in a five-weight percent aqueous solution. The amphiphilic tetrablock copolymer will usually precipitate in an aqueous bath at temperatures greater than 20 degrees Celsius to about 70 degrees Celsius. For example, the temperature can be at least 25, at least 30, at least 35, or at least 40 degrees Celsius and up to 70, up to 60, up to 50, or up to 40 degrees Celsius. After formation, the porous membrane is removed from the aqueous bath and dried. The resulting porous articles often have a surface that is hydrophilic at ambient temperature.

The porous article is usually hydrophilic with water being able to wick into the pores. The hydrophilic character of the porous article can be evident immediately upon contact with water. Alternatively, the porous article may swell when in contact with water and then become more hydrophilic.

The pores often are of a similar size and the porous article can be isoporous. In certain embodiments, the porous articles have pores that change in size from one surface, through the thickness of the membrane, to the opposing surface. For instance, often the pore size is on average smallest at one surface, increases throughout the body of the membrane, and is on average largest at the opposite surface. Process conditions and solvent choices can be selected to provide a porous membrane in which the pores at one surface (or both major surfaces) of the membrane have an average pore size (diameter) ranging from 1 to 500 nanometers. That is, the average pore size (diameter) on the surface is often at least 1 nanometer (nm), at least 2 nm, at least 5 nm, at least 10 nm, at least 20 nm, at least 30 nm, at least 40 nm, at least 50 nm, at least 75 nm, or at least 100 nm, and up to 500 nm, up to 450 nm, up to 400 nm, up to 350 nm, up to 300 nm, up to 250 nm, up to 200 nm, up to 100 nm, up to 75 nm, or up to 50 nm. The pore size can be characterized using Atomic Force Microscopic methods.

Porous membranes can be free-standing or positioned adjacent to (and often in contact with) a substrate that is porous. Suitable porous substrates include, for example, a porous polymeric material, a nonwoven substrate, a porous ceramic substrate, and a porous metal substrate. The substrates can have any desired shape or size. The thickness of the membrane, whether free-standing or supported by a substrate, is often in a range of 1 to 500 micrometers. The thickness can be at least 1 micrometer, at least 2 micrometers, at least 5 micrometers, at least 10 micrometers, at least 20 micrometers, at least 50 micrometers, at least 75 micrometers, or at least 100 micrometers and up to 500 micrometers, up to 400 micrometers, up to 300 micrometers, up to 200 micrometers, up to 100 micrometers, up to 75 micrometers, or up to 50 micrometers.

Advantageously, the porous membranes often have a toughness sufficient for easy handling of the membrane without becoming damaged.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| PO | Propylene oxide, >99 weight % | Sigma-Aldrich, |
| | | St. Louis, MO |
| EO | Ethylene oxide, >99.5 weight % | Sigma-Aldrich |
| Isoprene | 99 weight %, stabilized, product #: L14619 | Alfa Aesar, |
| | | Haverhill, MA |
| Butadiene | 1,3-butadiene, >99 weight % | Sigma-Aldrich |
| Styrene | S4972, obtained under the trade designation | Sigma-Aldrich |
| | “REAGENTPLUS” | |
| Allyl Glycidyl Ether | Allyl 2,3-epoxypropyl ether | Alfa Aesar |
| | 1-Allyloxy-2,3-epoxypropane, 97 weight % | |
| BEt₃ | Triethylborane, 1.0M solution in hexanes | Sigma-Aldrich |
| TBAB | Tetrabutylammonium bromide, 99 weight % | Alfa Aesar |
| CaH₂ | Calcium hydride, reagent grade, 95 weight % | Sigma-Aldrich |
| n-BuLi | n-butyl lithium, 1.6 Molar (M) in hexanes | Sigma-Aldrich |
| P2 Base | 1-tert-Butyl-2,2,4,4,4-pentakis(dimethylamino)- | Sigma-Aldrich |
| | 2λ⁵,4λ⁵-catenadi(phosphazene). CAS #: | |
| | 111324-03-9; dissolved in approximately 2.0M THF | |
| Toluene | Anhydrous, >99.8 weight % | Sigma-Aldrich |
| THF | Tetrahydrofuran, anhydrous, ≥99.9 weight %, | Sigma-Aldrich |
| | inhibitor-free | |
| DCM | Dichloromethane, obtained under the trade | EMD Millipore, |
| | designation “OMNISOLV” | Burlington, MA |
| Cyclohexane | Anhydrous, 99.5 weight % | Sigma-Aldrich |
| IPA | Isopropanol | VWR |
| | | International, |
| | | Batavia, IL |
| Ethanol | Denatured ethyl alcohol, pure, anhydrous, >99.5 | Sigma-Aldrich |
| | weight % | |
| Methanol | MX0480-6, obtained under the trade | EMD Millipore |
| | designation “OMNISOLV” | |
| Et-Carb | Diethylene glycol monoethyl ether, 98 weight % | Alfa Aesar |
| MTBE | Methyl tert-butyl ether | Sigma-Aldrich |
| Basic alumina | Aluminum oxide, activated, basic | Sigma-Aldrich |
| MgSO₄ | Magnesium sulfate, anhydrous | Sigma-Aldrich |
| HCl | Hydrochloric acid, aqueous, 37 weight % | EMD Millipore |
| THF | Tetrahydrofuran, obtained under the trade | EMD Millipore |
| | designation “OMNISOLV” | |
| Hexanes | HX0296, obtained under the trade designation | EMD Millipore |
| | “OMNISOLV” | |
| Acetone | 58019, obtained under the trade designation | EMD Millipore |
| | “OMNISOLV” | |
| PPO | Poly(propylene glycol), average Mn = 4 | Alfa Aesar |
| | kg/mol, obtained under product # 40815 | |
| PEO | Poly(ethylene glycol), average Mn = 20 kg/mol, | Sigma-Aldrich |
| | obtained under product # 81300 | |
| PEtOX | Poly(2-ethyl-2-oxazoline), M_{w} approximately | Sigma-Aldrich |
| | 50 kg/mol, PDI 3-4. | |
| P4VP | Poly(4-vinylpyridine), M_{w} approximately 60 | Sigma-Aldrich |
| | kg/mol | |
| PHEMA | Poly(2-hydroxyethyl methacrylate), M_{w} | Sigma-Aldrich |
| | approximately 20 kg/mol | |
| PMAA | Poly(methacrylic acid) sodium salt solution, | Sigma-Aldrich |
| | 30%, Mₙ approximately 5400 g/mol, M_{w} | |
| | approximately 9500 g/mol by GPC. | |
| I565 | 2,6-di-tert-butyl-4-(4,6-bis(octylthio)-1,3,5- | BASF, Florham |
| | triazin-2-ylamino) phenol, obtained under the | Park, NJ |
| | trade designation “IRGANOX 565” | |

### Test Methods

### Gel Permeation Chromatography (GPC)

The GPC equipment consisted of a 1260 Infinity LC (comprised of quaternary pump, autosampler, column compartment and diode array detector) from Agilent Technologies (Santa Clara, CA) operated at a flow rate of 1.0 mL/minute. The GPC column set was comprised of a PLgel MIXED-A (300 millimeter (mm) length×7.5 mm internal diameter) plus a PLgel MIXED-B (300 mm length×7.5 mm internal diameter,) both from Agilent Technologies. The detection consisted of a DAWN HELEOS II 18 angle Light Scattering detector, a VISCOSTAR viscometer and an OPTILAB T-rEX differential refractive index detector, all 3 from Wyatt Technology Corporation (Santa Barbara, CA). Data were collected and analyzed using software ASTRA version 6 from Wyatt Technology Corporation. The column compartment, viscometer and differential refractive index detector were set to 40° C.

The solvent and eluent (or mobile phase) consisted of tetrahydrofuran (stabilized with 250 parts per million of butylated hydroxytoluene) OMNISOLV grade modified with 5% v/v triethylamine (both from EMD Millipore Corporation, Burlington, MA).

### Nuclear Magnetic Resonance (NMR)

A portion of the polymer sample was analyzed as a solution of unknown concentration (generally approximately 12 milligrams/milliliter (mg/mL)) in CDCl₃. NMR spectra were acquired on a Bruker AVANCE 600 megahertz (MHz) NMR spectrometer equipped with an inverse cryoprobe.

### Differential Scanning Calorimetry (DSC)

The specimens were prepared for thermal analysis by weighing and loading the material into DSC sample pans. The specimens were analyzed using a DSC2500 (TA Instruments, New Castle, DE) utilizing a heat-cool-heat method (−50 to 200° C. at 10° C./minute). After data collection, the thermal transitions were analyzed using the TRIOS Software version 5.0. If present, any glass transitions (Tg) or significant endothermic or exothermic peaks were evaluated based on second heat flow curve. The glass transition temperatures were evaluated using the step change in the heat flow curve. The onset and midpoint (half height) of the transition were noted at the glass transition. Peak area values and/or peak minimum/maximum temperatures are also determined. Peak integration results are normalized for sample weight and reported in J/g.

### Atomic Force Microscopy (AFM) Test Method

All AFM images were obtained from a Bruker Dimension ICON AFM system (Billerica, MA). The AFM tip used is an OTESPA-R3 silicon tip with nominal spring constant of 42 N/m, resonant frequency between 200-400 kHz, and nominal tip radius of curvature of 7 nm.

AFM was used for pore sizing of the porous membranes and was performed with SPIP, Scanning Probe Image Processor, (6.7.7), an image metrology software, using the Particle and Pore Analysis feature. Prior to performing the pore analysis, a topographic image is typically processed using several steps: a 1st order polynomial fit to remove sample tilt, 0th order LMS fit (line wise correction) to remove horizontal skips (when necessary) and an L-filtering function to remove long wavelengths (ISO 16610 Gaussian L filter according to the ISO 25178-2 standard). The “advanced threshold” is the detection method for pores typically in the RMS factor threshold mode. In this mode, the threshold level is calculated by SPIP by multiplying the entered factor by the root mean square (RMS, equal to the standard deviation of Z values in the image). Other detection reference levels were also used depending on the ease at which the pores are detected.

### Cloud Points of Hydrophilic Blocks Used in Block Copolymer SIPS Membranes

Cloud points were determined by visual inspection of an aqueous solution of the corresponding hydrophilic homopolymer/copolymer. Polymers were dissolved in deionized water (when possible) to achieve a 5% mass solution. The aqueous solution was then placed in a recirculating water bath with temperature control. The temperature of the water bath was increased by 1° C. increments and allowed to stabilize for 10 minutes prior to sample inspection. Cloud points were recorded when the polymer solution displayed haze or visibly deviated from clarity.

### EXAMPLES

### Reagent Preparation

Styrene was stirred over CaH₂ overnight, degassed with three freeze-pump-thaw cycles, and then vacuum-transferred into a Schlenk bomb containing dried dibutyl-magnesium. After stirring overnight in an argon (Ar) atmosphere, styrene was again vacuum transferred into a receiving flask to afford a final, dry monomer. Isoprene was dried as detailed above for styrene with sequential vacuum transfers from CaH₂ and dibutyl-magnesium.

Propylene oxide was stirred over CaH₂ overnight, degassed with three freeze-pump-thaw cycles and condensed in a flask containing n-butyllithium (solvent removed in vacuo) cooled in liquid nitrogen. Propylene oxide was then thawed in an ice water bath at 0° C. and stirred for 30 minutes before collecting the purified monomer in a flask by vacuum transfer.

Ethylene oxide was condensed in a flask cooled in liquid nitrogen, degassed with three freeze-pump-thaw cycles and then condensed in a flask containing n-butyllithium (solvent removed in vacuo) cooled in liquid nitrogen. Ethylene oxide was then thawed in an ice water bath at 0° C. and stirred for 30 minutes before collecting the purified monomer in a flask by vacuum transfer.

Ethoxyethyl-glycidylether (EEGE) was prepared as described by Frey et. al. in J. Am. Chem. Soc., 2002, 124, 9698. EEGE was purified stirring over CaH₂ for 12 hours prior to filtration and vacuum distillation (approximately 150 millitorr (mtorr) at 40° C.).

Hydroxy-terminated polymers were dried prior to chain extension. This was accomplished by freeze-drying with benzene in the reaction flask.

The neutral form of PMAA was obtained by neutralization of the commercially available sodium salt. An aliquot of PMAA was neutralized at 0° C. using an ice bath and a 3-fold stoichiometric excess of 1 molar (M) HCl. After dropwise addition of HCl, the solution was stirred for 14 hours at room temperature at which time the pH of the solution was verified to be acidic (pH<6). Saturated sodium bicarbonate solution was then added dropwise to obtain a pH of 7. The polymer solution was then dried, and the resulting residue was dialyzed against deionized water.

Once purified by dialysis, the aqueous solution of neutral PMAA was dried by azeotropic distillation from benzene to afford a fine, white powder.

Glycidyl triethylene glycol monomethyl ether was synthesized as reported by Gandour (J. Org. Chem., 1983, 48(7), page 1116). The glycidyl triethylene glycol monomethyl ether was dried by distillation from CaH₂ at 108° C. (30 mtorr).

All other chemicals were used as received.

### Preparatory Example 1 (PE-1): Synthesis of Hydroxy-Terminated Poly(Styrene-b-Isoprene-b-Styrene): SIS-OH

SIS-OH was synthesized via anionic polymerization under rigorously dry and air-free conditions. A representative procedure for the synthesis of PE-1A is as follows. Cyclohexane (1.65 liters (L)) was added to a clean, dry 3 L reaction flask equipped with stir bar, argon, and a reagent inlet. Sec-BuLi (1.37 mL, effective concentration 1.45 M, 1.99 millimoles (mmol)) was added to the reaction flask and allowed to stir at room temperature for 10 minutes. Styrene (74.3 grams (g), 0.713 mole (mol)) was then added, causing a gradual color change to orange. The polymerization was stirred for 24 hours at room temperature prior to addition of isoprene (76.0 g, 1.12 mmol). After stirring an additional 24 hours at room temperature, the final charge of styrene (71.6 g, 0.687 mmol) was introduced to the reactor. To terminate the reaction, neat propylene oxide (5 mL, 71 mmol, excess) was added 24 hours later to form a clear, colorless polymer solution. SIS-OH was isolated by precipitation of the reaction solution from isopropanol (3 L) followed by filtration. A white, rubbery solid was obtained. ¹H-NMR analysis indicated a mass % composition of 66% polystyrene and 34% polyisoprene. GPC analysis of the polymeric product indicated a M_{w} of 102 kilograms/mole (kg/mol) and a polydispersity index (PDI) of 1.04.

PE-1B was synthesized as described for PE-1A with the amounts of reagents adjusted to obtain an SIS-OH polymer for which ¹H-NMR analysis indicated a mass % composition of 66% polystyrene and 34% polyisoprene. GPC analysis of the polymeric product indicated a M_{w} of 86 kilograms/mole (kg/mol) and a polydispersity index (PDI) of 1.01.

### Preparatory Example 2 (PE-2): Synthesis of Hydroxy-Terminated Poly(Styrene-b-Butadiene-b-Styrene): SBS-OH

SBS-OH was synthesized via anionic polymerization under rigorously dry and air-free conditions. Cyclohexane (1.75 L) was added to a clean, dry 3 L reaction flask equipped with stir bar, argon, and reagent inlet. Sec-BuLi (2.06 mL, effective concentration 1.45 M, 2.99 mmol) was added to the reaction flask and allowed to stir at room temperature for 10 minutes. Styrene (72.6 g, 0.697 mol) was then added, causing a gradual color change to orange. The polymerization was stirred for 24 hours at room temperature prior to addition of butadiene (73.0 g, 1.35 mol). After stirring an additional 24 hours at room temperature, the final charge of styrene (68.2 g, 0.655 mmol) was introduced to the reactor. To terminate the reaction, neat propylene oxide (5 mL, 71 mmol, excess) was added 24 hours later to form a clear, colorless polymer solution. SBS-OH was isolated by precipitation of the reaction solution from isopropanol (3 L) followed by filtration. A white, rubbery solid was obtained. ¹H-NMR analysis indicated a mass % composition of 66% polystyrene and 34% polybutadiene. GPC analysis of the polymeric product indicated a M_{w} of 76.3 kg/mol and a polydispersity index (PDI) of 1.04.

### Example 1 (EX-1): Synthesis of Poly(Styrene-b-Isoprene-b-Styrene-b-Propylene Oxide-Co-Glycidol): SIS-P/G

In a glovebox, SIS-OH PE-1A (30.6 g, 0.322 mmol —OH) and toluene (120 mL) were added to a sealable reaction flask equipped with stir bar. Once the polymer was dissolved, P2 base (150 μL, 0.300 mmol) was added and the reaction solution allowed to stir at room temperature for 20 minutes. Propylene oxide (19.5 mL, 279 mmol) and ethoxy-ethylglycidylether (13 mL, 86 mmol) were then added. Once the reaction achieved homogeneity, BEt₃ (1.25 mL, 1.25 mmol) was added and the reaction was sealed. The polymerization proceeded at room temperature for four days prior to precipitation from methanol (approximately 400 mL) and filtration. The white solid was then re-dissolved in THF (approximately 180 mL). To deprotect glycidol repeat units, HCl (10 mL, excess) was added and the solution was stirred for two hours. After addition for HCl, the viscosity of the solution visibly increased. SIS-P/G was then isolated by precipitation from water (approximately 400 mL) followed by filtration and drying. ¹H-NMR analysis indicated a mass % composition of 58% polystyrene, 29% polyisoprene, 11% polypropylene oxide, and 2% polyglycidol. GPC analysis of the polymeric product indicated a M_{w} of 118 kg/mol and a polydispersity index (PDI) of 1.05.

### Example 2 (EX-2): Synthesis of Poly(Styrene-b-Butadiene-b-Styrene-b-Propylene Oxide-Co-Glycidol): SBS-P/G

A representative procedure for the synthesis of EX-2A is as follows. In a glovebox, SBS-OH (PE-2) (47.2 g, 0.629 mmol —OH) and toluene (160 mL) were added to a 500 mL sealable reaction flask equipped with stir bar. Once a homogeneous solution was obtained, P2 base (0.31 mL, 0.62 mmol) was added and the deprotonation reaction continued at room temperature for 20 minutes. Propylene oxide (25 mL) and ethoxy-ethylglycidylether (25 mL) were then added to the reaction flask. Once the reaction achieved homogeneity, BEt₃ (2.0 mL, 2.0 mmol) was added and the reaction was sealed. The polymerization proceeded at room temperature for four days prior to precipitation from methanol (approximately 600 mL) and filtration. The white solid was then re-dissolved in THF (300 mL). To deprotect glycidol repeat units, HCl (5 mL, excess) was added and the solution was stirred for one hour. After addition for HCl, the solution became cloudy and the viscosity visibly increased. SIS-P/G was then isolated by precipitation from an aqueous solution of sodium bicarbonate (approximately 600 mL water, 40 g NaHCO₃) followed by washing with deionized water (twice with 300 mL), filtration and drying. EX-2B was prepared as described for EX-2A with the amounts of reagents adjusted as summarized in Table 2. ¹H-NMR and GPC

TABLE 2

| | PE-2, | Toluene, | P2 base, | Propylene | EEGE, | BEt₃, |
|---|---|---|---|---|---|---|
| | g | g | mmol | Oxide, g | g | mmol |
| EX-2A | 47.2 | 139 | 0.62 | 21 | 24 | 2.0 |
| EX-2B | 31.2 | 92 | 0.41 | 14 | 17 | 1.3 |

TABLE 3

| | | | Mass % | | | |
|---|---|---|---|---|---|---|
| | Mass % | Mass % | Propylene | Mass % | Mw, | |
| | Styrene | Butadiene | Oxide | Glycidol | kg/mol | PDI |
| EX-2A | 54 | 27 | 14 | 5 | 91 | 1.07 |
| EX-2B | 48 | 31 | 15 | 6 | 106 | 1.07 |

### Example 3 (Ex-3): Synthesis of Poly(Styrene-b-Isoprene-b-Styrene-b-Propylene Oxide-Co-Ethylene Oxide): SIS-P/O

A representative procedure for the synthesis of EX-3A is as follows. SIS-P/O was synthesized via anionic polymerization under rigorously dry and air-free conditions. SIS-OH polymer PE-1B (25.0 g, 0.29 mmol —OH) and toluene (84 g) were added to a 1 L reaction flask equipped with a stir bar. Once a homogeneous solution was obtained, P2 base (0.14 mL, 0.28 mmol) was added and the solution was stirred at room temperature for 15 minutes. Propylene oxide (11.5 g) and ethylene oxide (7.1 g) were then added to the reaction flask. Once the reaction achieved homogeneity, BEt₃ (0.86 mL, 0.86 mmol) was added. The polymerization proceeded at room temperature for four days prior to quenching with methanol, drying under vacuum to remove volatiles, and dissolution in THF (approximately 100 mL). SIS-P/O was then isolated by precipitation from distilled water (approximately 600 mL) followed by filtration and drying. The isolated polymer was further purified by dissolution in approximately 3.5 mL of THF per gram of polymer, precipitated from a distilled water and methanol mixture (approximately 7.5 mL and 15 mL of distilled water and methanol per g of polymer, respectively), triturated with approximately 10 mL distilled water per g polymer, triturated with 10 mL methanol per g polymer, and finally isolated by filtration and dried in a vacuum oven to give the final purified polymer. EX-3B was prepared as described for EX-3A with the amounts of reagents adjusted as summarized in Table 4. ¹H-NMR and GPC analysis of the polymeric products are listed in Table 5.

TABLE 4

| | PE-1B, | Toluene, | P2 base, | Propylene | Ethylene | BEt₃, |
|---|---|---|---|---|---|---|
| | g | g | mmol | Oxide, g | oxide, g | mmol |
| EX-3A | 25.0 | 84 | .28 | 11.5 | 7.1 | 0.86 |
| EX-3B | 25.3 | 93 | .29 | 15.0 | 3.7 | 0.87 |

TABLE 5

| | | | Mass % | Mass % | | |
|---|---|---|---|---|---|---|
| | Mass % | Mass % | Propylene | Ethylene | Mw, | |
| | Styrene | Isoprene | Oxide | Oxide | kg/mol | PDI |
| EX-3A | 51 | 27 | 13 | 9 | 86 | 1.14 |
| EX-3B | 51 | 27 | 17 | 5 | 91 | 1.16 |

### Example 4 (Ex-4): Synthesis of Poly(Styrene-b-Isoprene-b-Styrene-b-[Propylene Oxide-Co-Glycidyl Triethylene Glycol Monomethyl Ether])

PE-1B (26.5 g, 0.312 mmol —OH) was freeze-dried from benzene prior to chain extension. PE-1B was dissolved in a 350 mL sealable glass pressure flask with a stirbar and toluene (75.0 mL). Once completely dissolved, P2 base (0.300 mmol) was added and the deprotonation reaction was stirred for 15 minutes. After 15 minutes, propylene oxide (12 mL, 171 mmol) and glycidyl triethylene glycol monomethyl ether (23 mL, −103 mmol) was added. The resulting solution was stirred for −5 minutes before rapid addition of BEt₃ (1.2 mmol). The reaction was sealed and allowed to stir for four days at room temperature. The reaction was then precipitated from methanol before being isolated by filtration, re-dissolved in minimal THF (˜60 mL), and precipitated from water. ¹H-NMR analysis of the final, dried polymer showed a mass % composition of 57.2% poly(styrene), 30.5% poly(isoprene), and 12.3% poly(propylene oxide-co-glycidyl triethylene glycol monomethyl ether). The mass % ratio of propylene oxide to glycidyl triethylene glycol monomethyl ether was found to be 7.1:15.2.

### Example 5 (Ex-5): Synthesis of Poly(Styrene-b-Butadiene-b-Styrene-b-Propylene Oxide-Co-Ethylene Oxide): SBS-P/O

The procedure for the synthesis of EX-5 is as follows. SBS-P/O was synthesized via anionic polymerization under rigorously dry and air-free conditions. SBS-OH polymer PE-2 (25.0 g, 0.35 mmol —OH) and toluene (82 g) were added to a 1 L reaction flask equipped with a stir bar. Once a homogeneous solution was obtained, P2 base (0.17 mL, 0.34 mmol) was added and the solution was stirred at room temperature for 10 minutes. Propylene oxide (11.2 g) and ethylene oxide (6.7 g) were then added to the reaction flask. Once the reaction achieved homogeneity, BEt₃ (1.0 mL, 1.0 mmol) was added. The polymerization proceeded at room temperature for 50 hrs prior to quenching with methanol, drying under vacuum to remove volatiles, and dissolution in THF (approximately 100 mL). SIS-P/O was then isolated by precipitation from distilled water (approximately 600 mL) followed by filtration and drying. The isolated polymer was further purified by dissolution in approximately 175 mL of THF, precipitated from hexanes, triturated with approximately 300 mL methanol, isolated by filtration, and dried in a vacuum oven to give the final purified polymer. ¹H-NMR and GPC analysis of the polymeric product are listed in Table 6.

TABLE 6

| | | | Mass % | Mass % | | |
|---|---|---|---|---|---|---|
| | Mass % | Mass % | Propylene | Ethylene | Mw, | |
| | Styrene | Butadiene | Oxide | Oxide | kg/mol | PDI |
| EX-5 | 49 | 25 | 15 | 11 | 106 | 1.09 |

### Reference Examples (RE): Synthesis of Poly(Propylene Oxide)-Co-Poly(Glycidol) Copolymers: P/G

P/G copolymers were synthesized by Lewis-acid catalyzed anionic ring-opening polymerization under rigorously dry and air-free conditions. An exemplary reaction for RE-4 is detailed as follows. These reference examples correspond to the C block of the tetrablock copolymers.

In a glovebox, TBAB (200 mg, 0.62 mmol), propylene oxide (12.5 mL), ethoxy-ethylglycidylether (12.5 mL) and toluene (20 mL) were added to a 100 mL sealable reaction flask. The contents were stirred until a homogenous solution resulted. Once homogeneous, BEt₃ (1.87 mL, 1.87 mmol) was added via syringe and the flask was scaled. The reaction was stirred at room temperature for three days before isolation. Once the reaction was complete, MTBE (50 mL) was added and the solution sequentially washed with aqueous acetic acid (1×200 mL, approximately 1 M CH₃COOH), and water (2×150 mL). The organic fraction was then dried over MgS₄, filtered, and evaporated to dryness.

For deprotection of ethoxy-ethylglycidylether, the polymer was redissolved in IPA (approximately 150 mL) before concentrated HCl was added (3 mL, excess). The homogenous solution was stirred for 20 minutes before saturated sodium bicarbonate was slowly added (20 mL) to form a cloudy, white solution and neutralized the solution. After 30 minutes of stirring, solvent was removed under reduced pressure. The resulting white, viscous oil was triturated with 200 mL IPA. The IPA solution was filtered and again dried under reduced pressure. The resulting cloudy oil was diluted with deionized water (10 mL) and dialyzed against deionized water. Once dialyzed, the solution was dried under high vacuum to afford a clear, colorless viscous oil.

Sample RE-1 displayed low enough solubility in water to be purified by trituration. The sample was dissolved in water at 0° C. prior to trituration by heating to 50° C. followed by decant of water (cycle repeated 3×). Dialysis was not required for this sample.

TABLE 7
Reagent quantities and product characterization
for P/G polymers prepared using TBAB and BEt₃.

| | TBAB, | PPO, | EEGE, | BEt₃, | Toluene, | Mol % G | M_{w}^{a}, | |
|---|---|---|---|---|---|---|---|---|
| EXAMPLE | mg | mL | mL | mL | mL | in P/G | kg/mol | PDI^{a} |
| RE-1 | 240 | 20 | 5 | 2.25 | 30 | 12 | 39.8 | 1.14 |
| RE-2 | 240 | 17.5 | 7.5 | 2.25 | 30 | 17 | 37.6 | 1.20 |
| RE-3 | 240 | 15 | 10 | 2.25 | 30 | 28 | 38.7 | 1.15 |
| RE-4 | 200 | 12.5 | 12.5 | 1.87 | 20 | 35 | 39.0 | 1.12 |
| RE-5 | 180 | 10 | 15 | 1.68 | 20 | 41 | 36.9 | 1.14 |

^{a}GPC characterization data for respective P/E precursor prior to deprotection

TABLE 8
Cloud points for P/G polymers, homopolymers used
in previously reported block copolymer membranes,
and other hydrophilization additives

| EXAMPLE/MATERIAL | CLOUD POINT, ° C. |
|---|---|
| RE-1 | 12 |
| RE-2 | 19 |
| RE-3 | 25 |
| RE-5 | 34 |
| PPO | <0 |
| PEO | >95 |
| PEtOx | 62 |
| P4VP | >95 |
| P4VP | n.m.^{b} |
| PHEMA | n.m.^{b} |
| PMAA (neutral) | 90> × >75 |
| PMAA (Na salt) | >95 |

^{b}n.m. indicates polymers did not completely dissolve in 5% aqueous solutions at temperatures >8° C.

### Membrane Fabrication

A representative procedure for EX-10 follows. SBS-P/G (2.1 g) was added to a 20 mL scintillation vial with IRGANOX 565 (20 mg, 1 wt. %), THF (4.0 mL), and NMP (6.0 mL). The vial was sealed and agitated for 24 hours or until complete dissolution was achieved. Prior to casting, the solution was left undisturbed (degas) for 16 hours.

Membranes were cast onto a clean glass plate using a 8 mil (0.008 inch)×4 inch notch-bar coater (available from Gardco Paul N Gardner, Pompano Beach, FL). After casting, the glass plate and membrane were quickly (<5 sec from end of coater application) immersed in a deionized water non-solvent bath and allowed to precipitate undisturbed for at least 10 minutes. Membranes were then removed from the water bath and allowed to dry.

TABLE 9
Membrane casting conditions for amphiphilic tetrablock copolymers.

| | | WEIGHT % | | | PRECIP. | |
|---|---|---|---|---|---|---|
| | | TETRA-BLOCK | EVAP. | SOLVENT, | TEMP., | |
| EX. | POLYMER | COPOLYMER | TIME | v/v | ° C. | RESULT |
| EX-6 | EX-2A | 18.2 | 5 sec | 60/30 | 23 | Contraction in |
| | | | | THF/NMP | | water bath, |
| | | | | | | significant tears in |
| | | | | | | membrane |
| EX-7 | EX-2A | 17.9 | 5 sec | 60/40 | 23 | Contraction in |
| | | | | THF/NMP | | water bath, |
| | | | | | | significant defects |
| EX-8 | EX-2A | 17.9 | 5 sec | 60/40 | 40 | Contraction in |
| | | | | THF/NMP | | water bath, |
| | | | | | | significant defects |
| EX-9 | EX-2A | 18.0 | 5 sec | 50/50 | 23 | Some contraction, |
| | | | | THF/NMP | | no visible defects |
| EX-10 | EX-2A | 17.8 | 5 sec | 40/60 | 23 | Very minor |
| | | | | THF/NMP | | contraction, no |
| | | | | | | visible defects |
| EX-11 | EX-2A | 18.4 | 5 sec | 40/50/10 | 23 | Significant |
| | | | | THF/NMP/ | | contraction in water |
| | | | | IPA | | bath |
| EX-12 | EX-2A | 18.0 | 5 sec | 40/50/10 | 23 | No visible defects |
| | | | | THF/NMP/ | | |
| | | | | Diox | | |
| EX-13 | EX-2A | 18.1 | 5 sec | 40/50/10 | 23 | Very minor |
| | | | | THF/NMP/ | | contraction, no |
| | | | | Acetone | | visible defects |
| EX-14 | EX-2A | 18.8 | 5 sec | 40/30/30 | 23 | Very minor |
| | | | | THF/NMP/ | | contraction, no |
| | | | | Acetone | | visible defects |
| EX-15 | EX-2A | 18.4 | 5 sec | 50/40/10 | 23 | Too viscous to cast |
| | | | | THF/NMP/ | | |
| | | | | MeCN | | |
| EX-16 | EX-2A | 18.1 | 5 sec | 50/30/20 | 38 | No visible defects |
| | | | | THF/NMP/ | | |
| | | | | Et-Carb | | |
| EX-17 | EX-1 | 18.4 | 5 sec | 60/40 | 23 | Minor contraction, |
| | | | | THF/NMP | | no visible defects |
| EX-18 | EX-1 | 18.2 | 5 sec | 50/50 | 23 | No visible defects |
| | | | | THF/NMP | | |
| EX-19 | EX-1 | 18.7 | 5 sec | 50/40/10 | 23 | Minor contraction, |
| | | | | THF/NMP/ | | no visible defects |
| | | | | IPA | | |
| EX-20 | EX-1 | 18.7 | 5 sec | 60/30/10 | 23 | Minor contraction, |
| | | | | THF/NMP/ | | no visible defects |
| | | | | Diox | | |
| EX-21 | EX-1 | 18.7 | 5 sec | 50/40/10 | 24 | Too viscous to cast |
| | | | | THF/NMP/ | | |
| | | | | Diox | | |

### Membrane Testing

The flux of water or phosphate buffered saline (PBS) solution through membrane samples was measured as follows. For all tests, deionized water was used after being filtered with a point-of-use lab water purification system (obtained under the trade designation “MILLI-Q GRADIENT A10” from Millipore Sigma, Burlington, MA) to achieve a resistivity of 18.2 Mil-cm. PBS solution was prepared by dissolving phosphate buffered saline powder (obtained from Sigma-Aldrich, St. Louis, MO) in water in a 1 L volumetric flask. The PBS solution was then additionally filtered with a membrane with a pore rating of 0.1 micrometers (μm) (obtained under the trade designation “MICROPES 1F EL” from 3M Germany, Wuppertal, Germany).

Circular membrane discs with a diameter of 25 mm were die punched from sample sheets. Sample discs were immersed in water for 10 seconds prior to being loaded in a 25 mm stainless steel filter holder (obtained as part number “1209” from Pall Corporation, Port Washington, NY). Water or PBS solution was loaded in a stainless-steel pressure pot (obtained from Apache Stainless Equipment Corp., Beaver Dam, WI), pressurized with nitrogen and plumbed to the filter holder.

After purging air from the lines connecting the pressure pot to the filter holder, the flux of water or PBS solution was measured at an applied pressure of 1 bar, recording the mass of filtrate as a function of time. To calculate flux, the effective filtration area (EFA) was calculated using a diameter of 21 mm, and the mass flow rate was converted to volumetric flow rate using a density of 1 g/cm³ for both water and PBS buffer solution. The mass flow rate was determined via linear regression of the filtrate-versus-time data. The flux was then calculated using the following equation.

TABLE 10
Water flux of SIS-P/G membranes.

| | MEMBRANE CASTING CONDITIONS | | | WATER |
|---|---|---|---|---|
| | EVAP. | SOLVENT, | PRECIP. | FLUX, |
| EXAMPLE | TIME | v/v | TEMP., ° C. | LMH/bar |
| EX-17 | 5 seconds | 60/40 | 23 | 53 |
| | | THF/NMP | | |
| EX-18 | 5 seconds | 50/50 | 23 | 32 |
| | | THF/NMP | | |
| EX-19 | 5 seconds | 50/40/10 | 23 | 12 |
| | | THF/NMP/IPA | | |
| EX-20 | 5 seconds | 60/30/10 | 23 | 259 |
| | | THF/NMP/Diox | | |

TABLE 11
PBS solution flux of SBS-P/G membranes.

| | | | | PBS |
|---|---|---|---|---|
| | MEMBRANE CASTING CONDITIONS | | | SOLUTION |
| | EVAP. | SOLVENT, | PRECIP. | FLUX, |
| EXAMPLE | TIME | v/v | TEMP., ° C. | LMH/bar |
| EX-9 | 5 seconds | 50/50 | 23 | 71 |
| | | THF/NMP | | |
| EX-10 | 5 seconds | 40/60 | 23 | 23 |
| | | THF/NMP | | |
| EX-12 | 5 seconds | 40/50/10 | 23 | 163 |
| | | THF/NMP/Diox | | |
| EX-13 | 5 seconds | 40/50/10 | 23 | 184 |
| | | THF/NMP/Acetone | | |
| EX-14 | 5 seconds | 40/30/30 | 23 | 521 |
| | | THF/NMP/Acetone | | |
| EX-16 | 5 seconds | 50/30/20 | 38 | 170 |
| | | THF/NMP/Et-Carb | | |

### Atomic Force Microscopy (AFM) Analysis

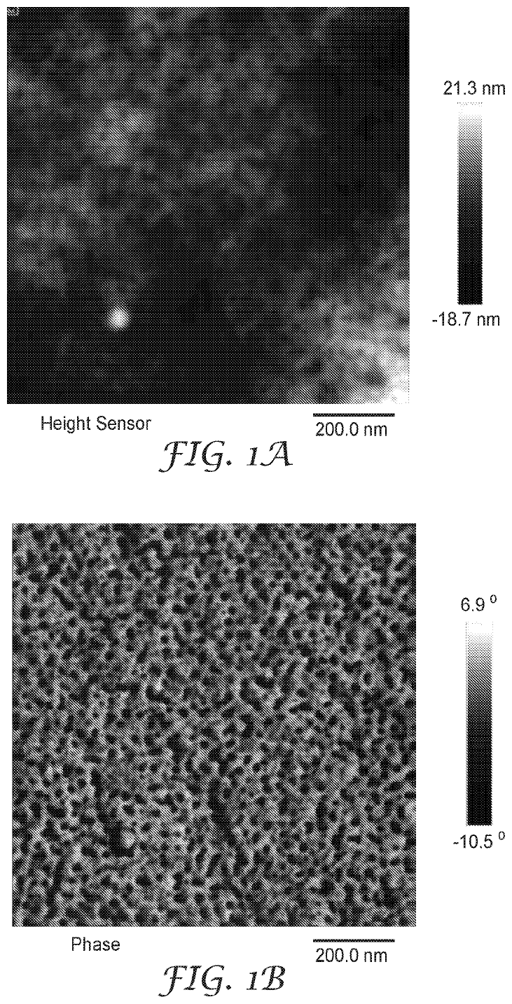

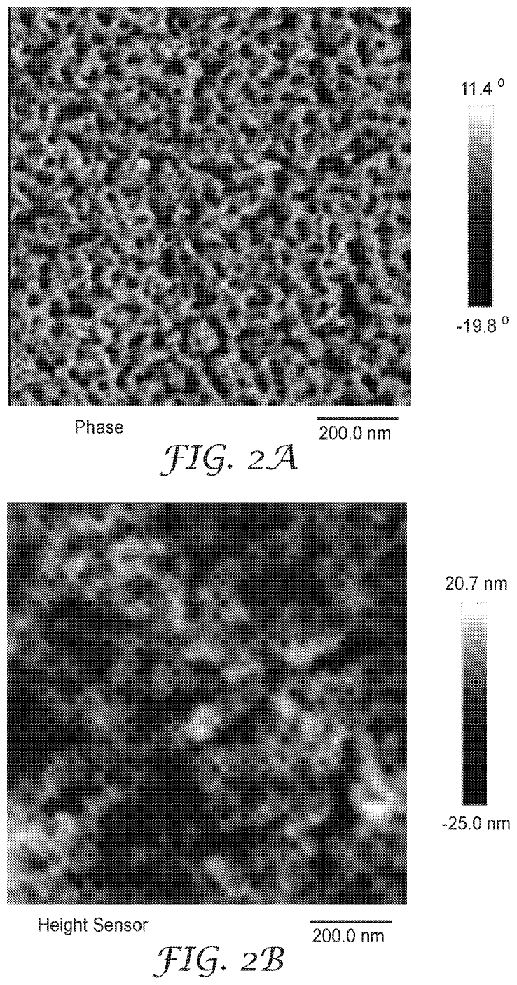

Example membranes EX-14 and EX-16 were analyzed by AFM according to the General Procedure for AFM Testing. The resulting images are in FIG. 1A (height) and FIG. 1B (phase) for EX-14 and in FIG. 2A (height) and FIG. 2B (phase) for EX-16.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A tetrablock copolymer of formula ABAC, the tetrablock copolymer comprising:
a) two A blocks, wherein each A block comprises monomeric units derived from a vinyl aromatic monomer;
b) a B block, wherein the B block comprises monomeric units derived from a conjugated diene monomer, wherein the B block is unsaturated or hydrogenated;
c) a C block comprising 10 to 70 mole percent first monomeric unit of Formula (I) and a 30 to 90 mole percent of second monomeric unit of Formula (II) 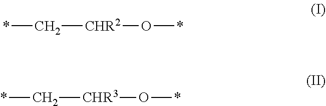
based on total moles of monomeric units in the C block wherein
R² is hydrogen, —CH₂OH, or —CH₂—(OCH₂CH₂)ₙ—OCH₃ where n is an integer ranging from 1 to 6;
R³ is an alkyl or a group of formula —CH₂—O—R⁴;
R⁴ is an alkyl or allyl group; and
each asterisk (*) indicates the attachment site to another monomeric unit in the C block.

2. The tetrablock copolymer of claim 1, wherein the tetrablock copolymer has a molecular weight ranging from 60,000 to 200,000 grams/mole.

3. The tetrablock copolymer of claim 1, wherein the tetrablock copolymer comprises at least 35 weight percent A block.

4. The tetrablock copolymer of claim 1, wherein the tetrablock copolymer has a weight ratio of the A blocks to the B block ranging from 4:1 to 1:1.

5. The tetrablock copolymer of claim 1, wherein the tetrablock has 10 to 30 weight percent C block.

6. The tetrablock copolymer of claim 1, wherein the tetrablock copolymer comprises 35 to 75 weight percent A blocks, 10 to 45 weight percent B block, and 10 to 30 weight percent C block based on the total weight of the tetrablock copolymer.

7. The tetrablock copolymer of claim 1, wherein the C block comprises 10 to 55 mole percent monomeric units of Formula (I) and 45 to 90 mole percent monomeric units of Formula (II) based on total moles of monomeric units in the C block.

8. The tetrablock copolymer of claim 1, wherein R² is —CH₂OH and R³ is —CH₃.

9. The tetrablock copolymer of claim 1, wherein the C block comprises a copolymer having a cloud point at temperatures greater than 10 degrees Celsius and lower than 60 degrees Celsius in a 5 weight percent aqueous solution.

10. The tetrablock copolymer of claim 1, wherein the polydispersity index is less than 1.5.

11. The tetrablock copolymer of claim 1, wherein the B block is hydrogenated and has a 0 to 40 mole percent of unsaturated carbon-carbon double bonds post hydrogenation.

12. An article comprising a tetrablock copolymer of claim 1.

13. The article of claim 12, wherein the article is a porous membrane or a porous hollow fiber.

14. The article of claim 13, wherein a surface of the porous membrane or porous hollow fiber is hydrophilic.

15. A method of making the tetrablock copolymer of claim 1, the method comprising:
mixing a first initiator for carbon-centered anionic polymerization with a first vinyl aromatic monomer in a reaction vessel;
forming a first reaction product that is a first polymeric block A comprising a polymerized product of at least 90 weight percent of the first vinyl aromatic monomer;
adding a conjugated diene monomer to the reaction vessel and forming a second reaction product that is a diblock copolymer of formula AB wherein the first polymer block A is bonded to a second polymer block B comprising a polymerized product of at least 90 weight percent of the conjugated diene monomer;
adding a second vinyl aromatic monomer that is the same or different than the first vinyl aromatic monomer to the reaction vessel and forming a third reaction product that is a triblock copolymer of formula ABA wherein the diblock copolymer of formula AB is bonded to a third polymer block A comprising a polymerized product of at least 90 weight percent of the second vinyl aromatic monomer;
forming and isolating a hydroxy-terminated triblock copolymer of formula ABA-R¹—OH from the third reaction product, wherein R¹ is ethylene or propylene;
mixing the hydroxy-terminated triblock copolymer with a second initiator for oxygen-centered anionic polymerization, a first oxirane compound, and a second oxirane compound different than the first oxirane compound; and
preparing the tetrablock copolymer of formula ABAC wherein the C block that comprises 10 to 70 mole percent first monomeric unit of Formula (I) and a 30 to 90 mole percent of second monomeric unit of Formula (II) based on total moles of monomeric units in the C block 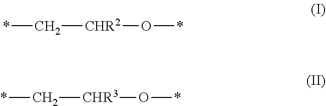
wherein
the monomeric unit of Formula (I) is derived from the first oxirane compound and the monomeric unit of Formula (II) is derived from the second oxirane compound;
R² is hydrogen, —CH₂OH, or —CH₂—(OCH₂CH₂)ₙ—OCH₃ where n is an integer ranging from 1 to 6;
R³ is an alkyl or a group of formula —CH₂—O—R⁴;
R⁴ is an alkyl or allyl group; and
each asterisk (*) indicates the attachment site to another monomeric unit in the C block.
